(19) United States
(12) Patent Application Publication
(10) Pub. No.: US 2019/0381685 A1
(43) Pub. Date: Dec. 19, 2019

(54) Pipe Drilling Tool And Method For Joining Pipes Using The Same

(71) Applicant: Tanaka Kyogyo Inc., Tokyo (JP)

(72) Inventor: Tomomi TANAKA, Tokyo (JP)

(73) Assignee: Tanaka Kyogyo Inc., Tokyo (JP)

(21) Appl. No.: 16/489,329

(22) PCT Filed: May 18, 2018
(86) PCT No.: PCT/JP2018/019277

§ 371 Date: Aug. 27, 2019

(30) Foreign Application Priority Data
Sep. 1, 2017 (JP) 2017-168366

(51) Int. Cl. B26F 1/36; B21D 28/34; B23K 31/02; F25B 41/00

(52) U.S. Cl. CPC B26F 1/36; F25B 41/00; B23K 31/027; B21D 28/34

(57) ABSTRACT

To provide a pipe drilling tool for forming, in a pipe, a hole for injecting a non-oxidizing gas such as nitrogen, when joining pipes such as refrigerant pipes by brazing, wherein the pipe drilling tool has a compact configuration allowing work thereof to be performed by the drilling tool being gripped by the hand of a user, does not readily generate burrs, and prevents cutting residue and burr residue from remaining in the pipe.

### TECHNICAL FIELD

The present invention relates to a pipe drilling tool and a method for joining pipes using the drilling tool. More specifically, the present invention relates to a pipe drilling tool for drilling a hole in a pipe such as a copper pipe used in air-conditioning facilities, and a method for joining pipes using the drilling tool.

### BACKGROUND ART

When air-conditioning facilities (also referred to as air conditioning facilities or air conditioning equipment) which are building facilities for air conditioning, specifically, adjustment of indoor environments such as temperature, humidity, and air cleanliness, and the like are set, an outdoor unit and an indoor unit are installed at set places, and a refrigerant pipe (hereinafter, sometimes merely referred to as a “pipe”) including two or more copper pipes is then required to be joined or connected in order to connect these units.

When pipes are joined in piping work, the following method may be performed. First, the diameter of an end portion of one of two pipes to be joined is enlarged (increased) to form an enlarged diameter portion, and an end portion of the other pipe is inserted into the enlarged diameter portion, to join a portion to be joined (a clearance between the end portions of the two combined pipes, and the like, hereinafter, sometimes merely referred to as the “clearance between the end portions of two pipes, and the like”, refer to a portion to be joined J in FIG. 12 and the like described later) by brazing. Here, the brazing is performed by pouring a molten brazing material into the portion to be joined and then cooling the brazing material to form a brazed portion. FIG. 18 is a view showing an example of conventional joining of pipes by brazing. A brazed portion B is formed in one pipe P1 including an enlarged diameter portion W formed at an end portion, and the portion to be joined of the end portion of the other pipe P2 (the enlarged diameter portion W is not formed at an end portion of the other pipe P2), to join the two pipes P1 and P2.

Meanwhile, if brazing is performed in the presence of air in the pipes when the pipes are joined, an oxide film (so-called soot) is formed on the inner surfaces of the pipes. When the air-conditioning facilities are used, the oxide film peeled off from the inner surface of the pipe by a heat exchange medium flowing in the pipe. As a result, the oxide film peeled off from the inner surface of the pipe contaminates the heat exchange medium or blocks a narrow place in the pipe, as in the case where foreign matters are mixed in the pipe. This disadvantageously causes lowered performance of the air-conditioning facilities and failure of the air-conditioning facilities or devices constituting them, so that the air-conditioning facilities cannot be disadvantageously operated normally.

In order to address the problem, the following work may be performed as a previous step of brazing work. A nitrogen cylinder is brought, and the inside of the pipe is purged with nitrogen using the brought nitrogen cylinder prior to brazing to replace the air in the pipe with nitrogen (see, for example, Patent Literature 1). According to the method for joining pipes disclosed in the document, brazing is performed in a state where the air in the pipe is substituted by nitrogen gas and the like, whereby the formation of an oxide film on the inner surface of the pipe can be prevented. As a result, the problems such as lowered performance the air-conditioning facilities and failure of the air-conditioning facilities are considered to be solved.

### CITATION LIST

### Patent Literature

Patent Literature 1: JP 3284720 B

### SUMMARY OF INVENTION

### Technical Problem

Here, when the inside of the pipe is purged with a non-oxidizing gas such as nitrogen to substitute the air in the pipe by the non-oxidizing gas, the following construction method is performed. A hole (open hole) is formed near a place in which a brazed portion is formed in the pipe to locally inject nitrogen from the hole.

The construction method makes it necessary to form the hole in the pipe in each of the vicinity of the portion in which the brazed portion (portion to be joined) is formed, and to form the hole so as to be orthogonal to the wall surface of the pipe. When a large-scale or complex device is used as the device for drilling the hole (also referred to as opening the hole, same as below) in the pipe, operation and the like is troublesome, and it takes time to learn the contents of work, so that a drilling tool which can be used by hands and has a compact configuration is desired. However, a simple pincer-like drilling tool conventionally used makes it difficult to insert a drilling blade into the pipe so as to be perpendicular to the pipe, so that the hole is obliquely formed with respect to the wall surface of the pipe in cross sectional view, and the generation of burrs cannot be avoided.

Here, the generation of the burrs causes a heat-retention material to be damaged when the pipe is covered with the heat-retention material while the heat-retention material is slid during construction. This causes a deteriorated heat-retention effect and durability. The generation of the burrs during forming makes it difficult to confirm the inflow of a welding material to a place to be joined, which makes it necessary to suppress the generation of the burrs.

In addition, drilling tools which have been provided so far pierce the pipe from the outside to the inside of the pipe, but when the drilling tools pierce the pipe from the outside to the inside of the pipe, cutting residue and burr residue may remain in the pipe. Meanwhile, the remaining of the cutting residue and the like in the pipe is the same as the formation of the oxide film on the inner surface of the pipe, which causes the above-described problems such as the influence on the heat exchange medium. Therefore, it has been required to provide a drilling tool which can prevent the cutting residue and the burr residue from remaining in the pipe.

The present invention has been made to solve the problems described above, and it is an object of the present invention to provide a pipe drilling tool for forming, in a pipe, a hole for injecting a non-oxidizing gas such as nitrogen, when joining pipes such as refrigerant pipes used for setting air-conditioning facilities by brazing, wherein the pipe drilling tool has a compact configuration allowing work thereof to be performed by the drilling tool being gripped by the hand of a user, does not readily generate burrs, and prevents cutting residue and burr residue from remaining in the pipe.

It is another object of the present invention to provide a method for joining pipes using the drilling tool, wherein the generation of an oxide film on the inner surface of the pipe when joining the pipes by brazing can be prevented.

### Solution to Problem

In order to solve the above-described problems, a pipe drilling tool according to the present invention is a pipe drilling tool for drilling a hole in a wall surface of a pipe, the pipe drilling tool including: a rod-like pedestal portion capable of being inserted into the pipe; a projecting convex blade attached to the pedestal portion with its tip facing an upper side; a die including a recessed portion facing the convex blade above the convex blade and capable of being fitted with the convex blade in order to sandwich the wall surface of the pipe to be drilled between the die and the convex blade; and a pair of handle portions including a rod-like member or a plate-like member capable of moving the die up and down closer to and away from the convex blade.

In the pipe drilling tool according to the present invention, in the above-described present invention, the pair of handle portions include a fixed handle portion fixed to a body portion for fixing the pedestal portion, and a moving handle portion attached to the body portion via a supporting point portion, and including a tip rotatable with the supporting point portion as a supporting point; the tip of the moving handle portion and the die are integrated with each other; and rotation of the tip of the moving handle portion is converted to an up-and-down movement of the die, to move the die up and down closer to and away from the convex blade.

In the pipe drilling tool according to the present invention, in the above-described present invention, the tip of the moving handle portion and the die are integrated by a fixing pin disposed in a fixing pin moving hole formed in the body portion in a direction orthogonal to the up-and-down movement; the rotation of the tip of the moving handle portion is converted to the up-and-down movement of the fixing pin; and the die is moved up and down by the up-and-down movement of the fixing pin.

In the pipe drilling tool according to the present invention, in the above-described present invention, the pedestal portion has a substantially cylindrical shape and an outer diameter of 4 to 12 mm.

In the pipe drilling tool according to the present invention, in the above-described present invention, the convex blade has a substantially cylindrical shape.

A method for joining pipes using the pipe drilling tool according to the present invention is a method for joining end portions of two pipes by brazing, wherein an enlarged diameter portion having an enlarged diameter is formed in the end portion of one of the two pipes to be joined, the method including: a drilling step of drilling an open hole appearing on the outside in one of the two pipes using the pipe drilling tool of the present invention; a gas introducing step of inserting an end portion of the other pipe into an end portion including an enlarged diameter portion formed in the one of the two pipes, and introducing a non-oxidizing gas into the two pipes from the open hole; and a brazing-joining step of joining the end portions of the two pipes and blocking the open hole by brazing.

In the method for joining pipes using the pipe drilling tool according to the present invention, in the above-described present invention, the drilling in the drilling step is performed in the enlarged diameter portion.

In the method for joining pipes using the pipe drilling tool according to the present invention, in the above-described present invention, the end portion of the other pipe is inserted into the end portion including the enlarged diameter portion formed in one of the two pipes in the gas introducing step such that the other pipe does not hide the open hole; and the non-oxidizing gas is introduced into the two pipes from the open hole, and the end portion of the other pipe is then further inserted to cause the other pipe to hide the open hole.

### Advantageous Effects of the Invention

The pipe drilling tool according to the present invention performs drilling by pressing a convex blade to an upper side from an inside toward an outside of a pipe so as to be orthogonal to a wall surface of the pipe. Therefore, a hole is formed so as to be orthogonal to the wall surface of the pipe, thereby achieving a process with which burrs are not liable to be generated, and expelling cutting residue and burr residue generated during drilling to the outside of the pipe, which makes it possible to prevent the residues from remaining in the pipe. In addition, the pipe drilling tool according to the present invention has relatively few component members, has a compact configuration with good operability allowing work thereof to be performed by a user gripping handle portions. The hole can be drilled using simple means, and therefore workability is also good.

According to the method for joining the pipes using the pipe drilling tool according to the present invention, the following effects of the present invention described above can be received: The two pipes are joined by brazing, whereby the pipes are firmly joined by a brazed portion. In addition, in the drilling step, the open hole is formed in the pipe by the pipe drilling tool according to the present invention, thereby providing good operability and workability, not being liable to generate burrs, and expelling cutting residue and burr residue generated during drilling to the outside of the pipe, which makes it possible to prevent the residues from remaining in the pipe. Since the insides of the two pipes are substituted by the non-oxidizing gas in the gas introducing step, the formation of the oxide film on the inner surface of the pipe can be prevented in the brazing-joining step as the subsequent step, and a problem can be avoided, in which the formation of the oxide film causes lowered performance of the air-conditioning facilities and failure of the air-conditioning facilities or devices constituting them.

### BRIEF DESCRIPTION OF DRAWINGS

FIG. 1 is a perspective view showing an aspect of a pipe drilling tool.

FIG. 2 is a front view showing an aspect of a pipe drilling tool.

FIG. 3 is a front view showing an aspect of a pipe drilling tool.

FIG. 4 is a view for illustrating the up-and-down movement of a die.

FIG. 5 is a view for illustrating the up-and-down movement of a die.

FIG. 6 is a perspective view showing a state where a pedestal portion is inserted into a pipe in FIG. 1.

FIG. 7 is a view showing a drilling step of a pipe.

FIG. 8 is a view showing a drilling step of a pipe.

FIG. 9 is a view showing a drilling step of a pipe.

FIG. 10 is an illustration diagram showing a drilling step of a pipe.

FIG. 11 is a view showing an example of an internal structure in the vicinity of a moving portion.

FIG. 12 is a view showing two pipes to be joined.

FIG. 13 is a view showing an example of a state where an end portion of other pipe is inserted into an end portion including an enlarged diameter portion formed in one pipe.

FIG. 14 is a view showing a state where the end portion of the other pipe is further inserted in FIG. 13.

FIG. 15 is a view showing another example of a state where an end portion of other pipe is inserted into an end portion including an enlarged diameter portion formed in one pipe.

FIG. 16 is a view showing an example in which the configuration shown in FIG. 14 is brazed.

FIG. 17 is a view showing an example in which the configuration shown in FIG. 15 is brazed.

FIG. 18 is a view showing an example of conventional joining of pipes by brazing.

### DESCRIPTION OF EMBODIMENTS

(A) Regarding Pipe Drilling Tool 1:

Hereinafter, one aspect of a pipe drilling tool 1 according to the present invention will be described.

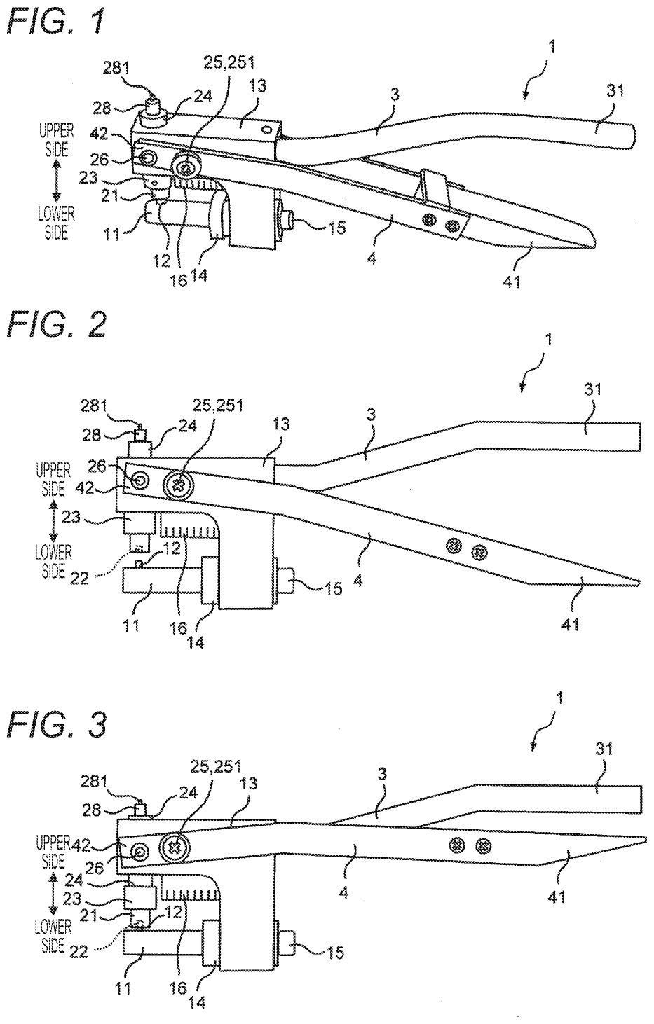

FIG. 1 is a perspective view showing an aspect of a pipe drilling tool 1. FIGS. 2 and 3 are front views respectively showing an aspect of a pipe drilling tool 1 (FIG. 2 shows a state where a space between a grasping side 31 of a fixed handle portion and a grasping side 41 of a moving handle portion is opened, and a space between a convex blade 12 and a die 21 is opened (hereinafter, sometimes referred to as an “opened state”), and FIG. 3 shows a state where the space between the grasping side 31 of the fixed handle portion and the grasping side 41 of the moving handle portion is closed, and the space between the convex blade 12 and the die 21 is closed (hereinafter, sometimes referred to as a “closed state”)). In FIGS. 1 to 3, numeral number 1 designates a pipe drilling tool; 11, a pedestal portion; 12, a convex blade; 21, a die; 22, a recessed portion; 3, a fixed handle portion; and 4, a moving handle portion, respectively.

(1) Configuration of Pipe Drilling Tool 1:

The pipe drilling tool 1 according to the present invention (hereinafter, sometimes merely referred to as a “drilling tool 1”) is a pipe drilling tool 1 for drilling a hole H (see FIGS. 8 to 16 and the like described later) in the wall surface of a pipe P. The pipe drilling tool 1 includes, as a basic configuration: a rod-like pedestal portion 11 capable of being inserted into the pipe P; a projecting convex blade 12 attached to the pedestal portion 11 with its tip facing an upper side; a die 21 including a recessed portion 22 facing the convex blade 12 above the convex blade 12 and capable of being fitted with the convex blade 12 in order to sandwich the wall surface of the pipe P to be drilled between the die 21 and the convex blade 12; and a pair of handle portions 3 and 4 including a rod-like member or a plate-like member capable of moving the die 21 up and down closer to and away from the convex blade 12. Drilling is performed by placing and sandwiching the wall surface of the pipe P to be drilled between the convex blade 12 and the recessed portion 22 facing each other, and fitting the convex blade 12 into the recessed portion 22.

Each of members included in the drilling tool 1 can be formed with desired materials such as metal materials (such as steel materials). The rod-like pedestal portion 11 included in the drilling tool 1 is inserted into the pipe P during drilling (see FIGS. 6 to 10 and the like), to perform holding of the pipe P or the like during drilling. In the present embodiment, the rod-like pedestal portion 11 shown has a substantially cylindrical shape. Meanwhile, the shape of the pedestal portion 11 is not limited to the substantially cylindrical shape. For example, any shape such as a prismatic shape or a polygonal pillar shape can be used, but the pedestal portion 11 preferably has the substantially cylindrical shape since the pipe P to be drilled has a circular cross section.

In the present embodiment, the pedestal portion 11 shown is fixed and attached to a body portion 13 including a plate-like member having a substantially inverted L-shape in plan view (see FIG. 2 and the like, the L-shape shown upside down (rotated by 180°)). The pedestal portion 11 is attached to the body portion. 13 using a bolt 15. Specifically, the fixing bolt 15 is inserted into the hole (not shown) of the body portion 13 drilled such that the bolt 15 can pass. The tip of the bolt 15 may be inserted into the threaded tip of the pedestal portion 11 which can be fixed by the bolt 15, to screw (bolt) the pedestal portion 11.

The drilling tool 1 is not particularly limited, but can cope with the drilling of the pipe P having a diameter of about 6 mm or more, and the size (thickness) of the pedestal portion 11 may be appropriately determined by the size of the pipe P in which the hole H is drilled (for example, the outer diameter of the pipe P and the thickness of the wall surface, and the like). When the pedestal portion 11 has a substantially cylindrical shape, the pedestal portion 11 preferably has an outer diameter of about 4 to 12 mm and a length of about 20 to 40 mm, without being particularly limited to these ranges.

The projecting convex blade 12 is attached to the rod-like pedestal portion 11 with its tip directed to an upper side (see arrow directions in FIG. 1 and the like for an upper side and a lower side opposite to the upper side). The convex blade 12 has such a shape that it can be fitted into the recessed portion 22 of the die 21 described later. In the present embodiment, the convex blade 12 has a flat tip directed to an upper side, and has a substantially cylindrical shape. The size of the convex blade 12 corresponds to the size of the hole H to be formed as with the size of the recessed portion 22 described later, and thus may be determined by the size of the hole H, and the like. For example, when the convex blade 12 has a substantially cylindrical shape, the convex blade 12 preferably has an outer diameter of about 1 to 4 mm and a length of 1 to 4 mm, without being particularly limited to these ranges.

It is preferable that a position where the convex blade 12 is attached to the pedestal portion 11 is separately placed by about 2 to 7 mm from the tip of the rod-like pedestal portion 11. By attaching the convex blade 12 in such a range, work can be stably performed. For example, a portion in which the hole H is formed can be efficiently positioned.

As shown in FIG. 1 and the like, in the present embodiment, a positioning portion 14 having a substantially ring shape is attached to the pedestal portion 11. For example, the tip of the pipe P into which the pedestal portion 11 is inserted can be positioned. When the outer diameter of the pipe P is relatively large (such as a size capable of inserting the positioning portion 14), the positioning portion 14 may be inserted into the pipe P. The positioning portion 14 can be fixed to the pedestal portion 11 by, for example, a bolt (not shown) and the like.

In the present embodiment, a scale portion 16 with a scale is attached to the inner side of the body portion 13 having a substantially inverted L-shape in plan view. For example, in a state where the pedestal portion 11 is inserted into the pipe P, the drilled position of the pipe P and the like is likely to be specified by allocating the tip of the pipe P to the scale of the scale portion 16.

The die 21 is positioned above the tip of the convex blade 12 so as to face the convex blade 12 in order to sandwich the wall surface of the pipe P to be drilled between the die 21 and the convex blade 12. The recessed portion 22 facing the convex blade 12 and capable of being fitted with the convex blade 12 is formed in the die 21. The convex blade 12 and the recessed portion 22 are disposed thus, whereby the convex blade 12 is pressed to an upper side so as to be orthogonal to the wall surface of the pipe P during drilling, to fit the convex blade 12 into the recessed portion 22.

In the drilling tool 1 of the present invention, by bringing the projecting convex blade 12 attached to the pedestal portion 11 inserted into the pipe P and the recessed portion 22 formed in the die 21 located outside the pipe P and located above the convex blade 12 close to the convex blade 12, the convex blade 12 pressed to an upper side so as to be orthogonal to the wall surface of the pipe P, and the wall surface of the pipe P is pierced from the inside of the pipe P to drill the hole, thereby fitting the convex blade 12 into the recessed portion 22. Thus, the drilling tool 1 according to the present invention performs drilling by pressing the convex blade 12 to an upper side from the inside toward the outside of the pipe P so as to be orthogonal to the wall surface of the pipe P, whereby the hole H is formed so as to be orthogonal to the wall surface of the pipe P, thereby achieving a process with which burrs are not liable to be generated, and expelling cutting residue and burr residue generated during drilling to the outside the pipe P, which makes it possible to prevent the residues from remaining in the pipe P.

The die 21 in which the recessed portion 22 is formed is integrally formed with an upper die fixing portion 23 and a moving portion 24 attached so as to be movable up and down with respect to the body portion 13. In the present embodiment, all of the die 21, the die fixing portion 23, and the moving portion 24 are formed in a substantially cylindrical shape, and the moving portion 24 is inserted into a through hole of the body portion 13 having a substantially inverted L-shape in plan view so as to be movable up and down.

The up-and-down movement of the moving portion 24 and the integrated die 21 and the like is achieved by a fixed handle portion 3 fixed and attached to the body portion 13, and a moving handle portion 4 including a tip rotatable with the supporting point portion 25 as a supporting point. Since the drilling tool 1 according to the present invention has few component members, and allows work thereof to be performed by a user gripping handle portions (the fixed handle portion 3 and the moving handle portion 4) as described above, the drilling tool 1 has a compact configuration with good operability. In the present invention, the “fixed” of the “fixed handle portion 3” and the “moving” of the “moving handle portion 4” refer to fixation with respect to the body portion 13 or attachment so as to be movable.

The fixed handle portion 3 is a rod-like member fixed and attached to the body portion 13 for fixing the pedestal portion 11 so as to extend from the side end of the body portion 13 (see FIG. 2 and the like). In the present embodiment, the substantially cylindrical rod-like member is processed into a predetermined shape.

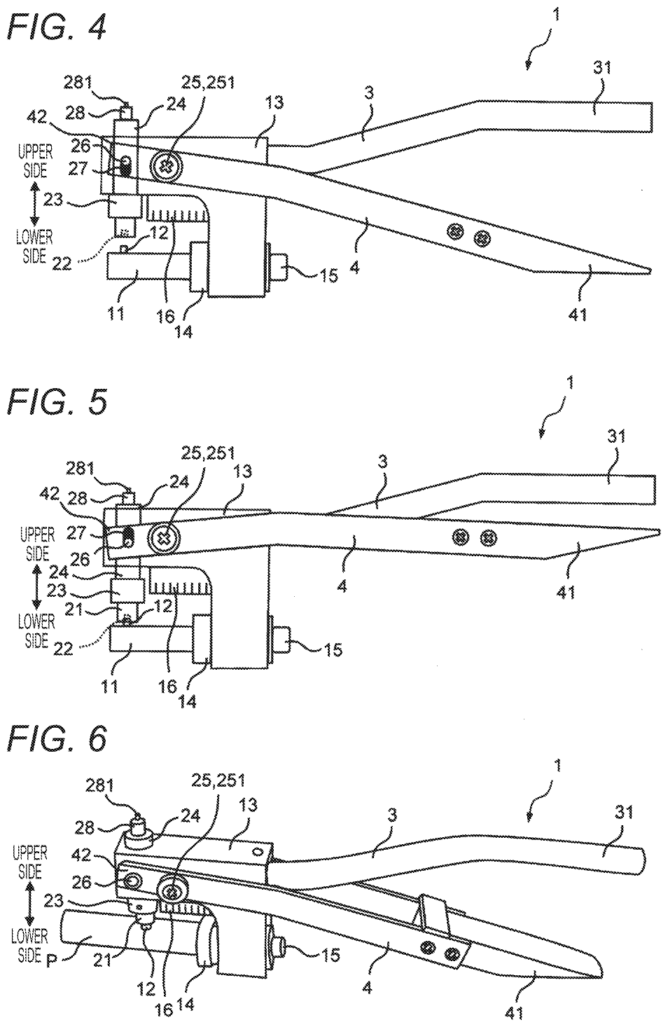

The moving handle portion 4 is attached by fixing two plate-like members with a screw 251 so as to sandwich the body portion 13 between the two plate-like members. A tip 42 of the moving handle portion (refer to a side opposite to the grasping side 41, same as below) is rotatable with the screwed portion (supporting point portion 25) as a supporting point. A fixing pin 26 is disposed in a fixing pin moving hole 27 (see FIGS. 4 and 5) formed in the body portion 13 such that the axial direction of the fixing pin 26 is orthogonal to the up-and-down movement of the die 21. The tip 42 of the moving handle portion is integrated with the moving portion 24 inserted into the body portion 13 by the fixing pin 26. The die 21 integrated with the moving portion 24 is also integrated with the tip 42 of the moving handle portion by the fixing pin 26. By such integration, the rotation of the tip 42 of the moving handle portion with the supporting point portion 25 as the supporting point is converted to the up-and-down movement of the fixing pin 26, and the up-and-down movement of the fixing pin 26 is converted to the up-and-down movement of the moving portion and the integrated die 21 and the like, whereby the die 21 is moved up and down closer to and away from the convex blade 12.

FIGS. 4 and 5 are views for illustrating the up-and-down movement of the die 21. In FIGS. 4 and 5, the entire moving portion 24 is illustrated so as to appear such that the up-and-down movement of the fixing pin 26 which integrates the moving handle portion 4 with the moving portion 29 can be understood. In addition, a fixing pin moving hole 27 formed in the body portion 13 but hidden by the moving handle portion 4 to disappear in FIGS. 1 to 3 also appears. In contrast, members are partially omitted and illustrated.

As shown in FIG. 4, in a state where a space between the grasping side 31 of the fixed handle portion and the grasping side 41 of the moving handle portion is opened, the tip 42 of the moving handle portion is located on the upper side. In the opened state, the fixing pin 26 attached to the tip 42 of the moving handle portion is also located on the upper side in the fixing pin moving hole 27 (black portions in the body portion 13 shown in FIGS. 4 and 5) as a substantially elliptical through hole formed in the body portion 13. Similarly, the moving portion 24, the die fixing portion 23, and the die 21 integrated by the fixing pin 26 are also located on an upper side with respect to the pedestal portion 11 to which the convex blade 12 is attached, whereby the space between the convex blade 12 attached to the pedestal portion 11 and the die 21 (and the recessed portion 22 formed in the die 21) is set in an opened state.

From this opened state, the grasping side 41 of the moving handle portion is brought close to the grasping side 31 of the fixed handle portion to narrow a relative distance between the grasping side 41 of the moving handle portion and the grasping side 31 of the fixed handle portion. Therefore, the tip 42 of the moving handle portion is rotated to a lower side with the supporting point portion 25 as the supporting point, and the fixing pin 26 attached to the tip 42 of the moving handle portion is moved to a lower side in the fixing pin moving hole 27. The moving portion 24, the die fixing portion 23, and the die 21 integrated by the fixing pin 26 are also moved to a lower side toward the pedestal portion 11 to which the convex blade 12 is attached. The space between the convex blade 12 attached to the pedestal portion 11 and the die 21 (and the recessed portion 22 formed in the die 21) is set in a closed state. As shown in FIG. 5, the convex blade 12 is fitted into the recessed portion 22 formed in the die 21.

The depth of the recessed portion 22 into which the convex blade 12 is fitted may be determined according to the length of the convex blade 12. The depth of the recessed portion 22 is preferably, for example, 2 to 8 mm, without being particularly limited to this range. The inner diameter of the recessed portion 22 is 1.1 to 4.5 mm when the convex blade 12 has a substantially cylindrical shape. A clearance between the convex blade 12 and the recessed portion 22 is preferably about 0.05 to 0.25 mm (more preferably 0.05 to 0.2 mm). The clearance and the like may depend on the material and the like of the pipe P, without being particularly limited to this range.

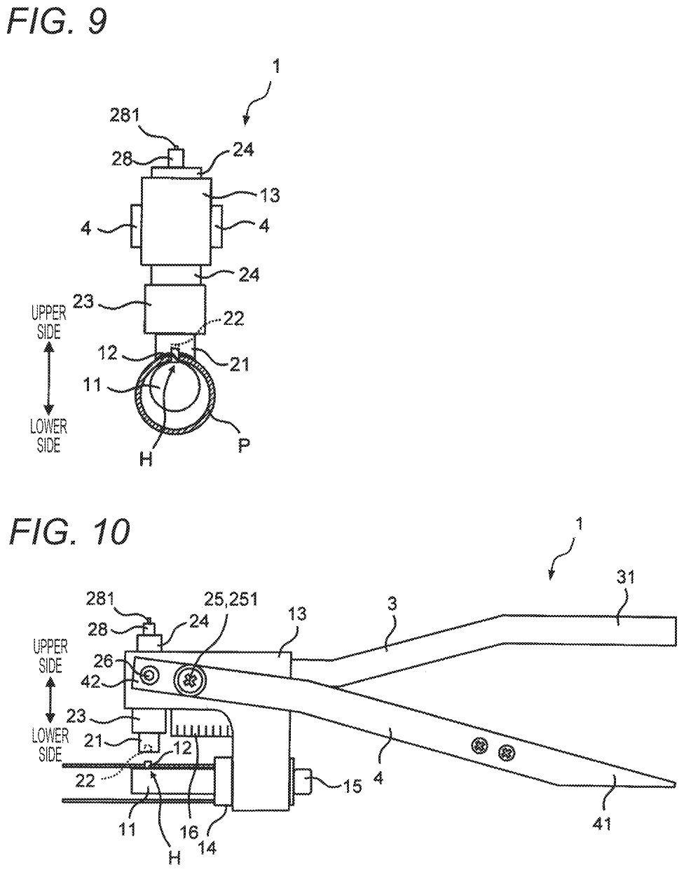

The tip of the die 21 is preferably arch-shaped so as to form a recess toward the tip of the convex blade 12 in consideration of contact with the wall surface of the pipe P having a circular cross section, to be drilled (see also FIG. 9 described later). In consideration of the thickness of the pipe P to be drilled, a clearance of 1 to 4 mm is preferably formed without bringing the pedestal portion 11 to which the convex blade 12 is attached into contact with the tip of the die 21 even in a state where the moving handle portion 4 is closed.

(2) One Example of Method for Drilling Pipe P:

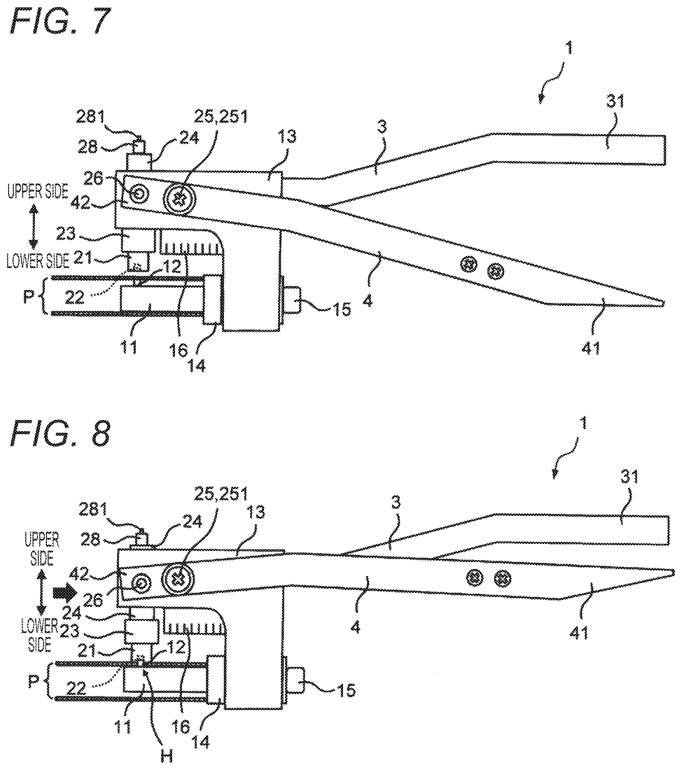

FIG. 6 is a perspective view showing a state where a pedestal portion 11 is inserted into a pipe P in FIG. 1. FIGS. 7, 8, and 10 are views showing a drilling step of a pipe P in a state where a pedestal portion 11 is inserted into the pipe P. FIG. 9 is a view as viewed from the direction of a black bold arrow in FIG. 8. In FIG. 9, some members such as the body portion 13 are not illustrated.

One example of the method for drilling the pipe P using the pipe drilling tool 1 according to the present invention will be described using FIGS. 7 to 10. First, as shown in FIG. 7, the space between the grasping side 31 of the fixed handle portion and the grasping side 41 of the moving handle portion is set in an opened state. In the state where the space between the convex blade 12 and the die 21 is opened, the pedestal portion 11 is inserted into the pipe P to be drilled, to dispose the wall surface of the pipe P between the projecting convex blade 12 and the die 21 including the recessed portion 22.

When the wall surface of the pipe P is disposed between the convex blade 12 and the die 21, the grasping side 41 of the moving handle portion is moved to the grasping side 31 of the fixed handle portion, whereby the space between the grasping sides 31 and 41 of both the handles is set in a closed state. As a result, the tip 42 of the moving handle portion is rotated to a lower side with the supporting point portion 25 as the supporting point, whereby the fixing pin 26 attached to the tip 42 is moved to a lower side in the fixing pin moving hole 27 (see FIGS. 4 and 5). The moving portion 24 integrated by the fixing pin 26 is also moved to a lower side.

By the movement of the moving portion 24 to the lower side, the die fixing portion 23 and the die 21 integrated with the moving portion 24 are also moved to the lower side toward the pedestal portion 11 to which the convex blade 12 is attached, and the convex blade 12 and the die 21 relatively approaches. As shown in FIGS. 8 and 9, the convex blade 12 attached to the pedestal portion 11 pierces the wall surface of the pipe P to the upper side from the inside of the pipe P so as to be orthogonal to the wall surface of the pipe P. The convex blade 12 is fitted into the recessed portion 22 formed in the die 21, whereby the space between the convex blade 12 and the die 21 is set in a closed state, thereby performing drilling to form the hole (open hole) H.

Thus, when the hole H is formed and drilling is completed, as shown in FIG. 10, the space between the grasping side 31 of the fixed handle portion and the grasping side 41 of the moving handle portion is opened, to return to the opened state of the space between the convex blade 12 and the die 21. A portion of the pipe P in which the hole H is drilled is removed from the convex blade 12 to take out the pedestal portion 11 from the pipe P.

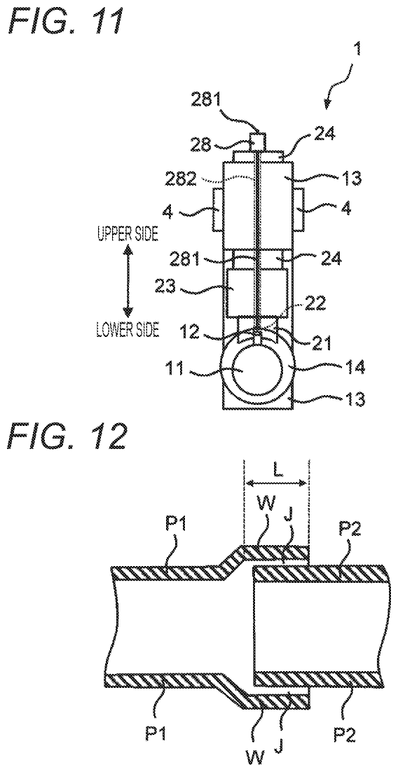

FIG. 11 is a view showing an example of an internal structure in the vicinity of the moving portion 24. Since the convex blade 12 pierces the wall surface to the upper side from the inside toward the outside of the pipe P as described above, the cutting residue and the burr residue in drilling are discharged to the outside of the pipe P. In some cases, the cutting residue and the like remains in the recessed portion 22. For example, as shown in FIG. 11, a through hole 282 penetrating the integrated moving portion 24, die fixing portion 23, and die 21 is formed so as to be connected from the recessed portion 22, and a cutting residue removing member 28 including a rod-like member 281 also reaching the inside of the recessed portion 22 is attached in the through hole 282. The cutting residue and the like can be pushed to the outside of the recessed portion 22 by the cutting residue removing member 28. When such a through hole 282 is formed, the recessed portion 22 is connected to the through hole 282, and has no bottom surface, but in the present invention, the recessed portion 22 includes also one having no bottom surface.

The pipe drilling tool 1 according to the present invention described above performs drilling by pressing the convex blade 12 to the upper side from the inside toward the outside of the pipe P so as to be orthogonal to the wall surface of the pipe P. Therefore, the hole H is formed so as to be orthogonal to the wall surface of the pipe P, thereby achieving a process with which burrs are not liable to be generated, and expelling cutting residue and burr residue generated during drilling to the outside of the pipe P, which makes it possible to prevent the residues from remaining in the pipe P. In addition, the pipe drilling tool 1 according to the present invention has few component members, has a compact configuration with good operability allowing work thereof to be performed by the user gripping handle portions 3 and 4. The hole H can be drilled using simple means, and therefore workability is also good.

(B) Method for Joining Pipes P Using Pipe Drilling Tool 1:

Next, one aspect of a method for joining the pipes P using the pipe drilling tool 1 mentioned in (A) will be described. A method for joining pipes P using the pipe tool 1 (hereinafter, sometimes merely referred to as a “method for joining pipes P”) is, for example, a method for joining pipes P1 and P2, wherein: end portions of the two pipes P1 and P2 are joined by brazing; and an enlarged diameter portion W having an enlarged diameter is formed in the end portion of one pipe P1 of the two pipes P1 and P2 to be joined. The method includes, as basic steps, a drilling step of drilling an open hole H appearing on the outside in one pipe of the two pipes P1 and P2 using the pipe drilling tool 1 according to the present invention; a gas introducing step of inserting an end portion of the other pipe P2 into an end portion including an enlarged diameter portion H formed in the one pipe P1 of the two pipes P1 and P2, and introducing a non-oxidizing gas into the two pipes P1 and P2 from the open hole H; and a brazing-joining step of joining the end portions of the two pipes P1 and P2 and blocking the open hole H by brazing.

(1) Regarding Pipe P to be Joined:

Examples of the two pipes P1 and P2 to be joined include copper pipes used for refrigerant pipes and the like, metal pipes made of aluminum, stainless steel and the like, and various pipes made of synthetic resins such as polyethylene, polypropylene, and polyvinyl chloride. The type of the material of the pipe is not particularly limited. In the pipes P1 and P2, an end portion of one pipe P1 of the two pipes P1 and P2 is enlarged in diameter (the diameter is enlarged for increasing) to form the enlarged diameter portion W. FIG. 12 is a view showing two pipes P1 and P2 to be joined, and shows a pipe (one pipe P1) including an enlarged diameter portion W formed at its end portion and the other pipe P2 including no enlarged diameter portion W.

Means for enlarging the diameter of the pipe P (for forming the enlarged diameter portion W) is not particularly limited, and conventionally known means using a predetermined jig or method (for example, bulge processing (bulge forming) and the like) may be used. The pipe P including an end portion having a diameter enlarged in advance may be used. Although not shown, a tubular joining member separately prepared, and the joining member is attached to the end portion of one pipe P to form the enlarged diameter portion W without any problem.

The length L of the enlarged diameter portion W (see FIG. 12, refer to the internal length L of the pipe P1) is preferably in a range of 5 to 50 mm in consideration of workability and the like, but it is not particularly limited to this range. The inner diameter of the enlarged diameter portion W may be generally larger than the outer diameter of the inserted other pipe P2 by 1 to 5 mm (the clearance between the end portions is 0.5 mm to 2.5 mm), but it is not particularly limited to this range.

(2) Drilling Step:

The drilling step is a step of forming an open hole H for introducing a non-oxidizing gas into the two pipes P1 and P2 in a gas introducing step described later, and the open hole H is formed by the above-described pipe drilling tool 1 according to the present invention. By forming the open hole H with the drilling tool 1 according to the present invention, the following effects of the present invention can be received: There are provided good operability and workability, not being liable to generate burrs, expelling burr residue and the like generated to the outside of the pipe P, and capable of forming the open hole H by simple means. Since the drilling method with respect to the pipe P is described as an example in the above-described (A) (2), the description is omitted.

The open hole H may be formed in the enlarged diameter portion (enlarged diameter portion W) of a pipe having an enlarged diameter (one pipe P1) and a predetermined position (for example, an end portion or vicinity thereof, and the like) of a pipe having a non-enlarged diameter (other pipe P2). For example, by forming the open hole H in the enlarged diameter portion W, the open hole H is a window for confirming whether a brazing material is properly poured into a portion to be joined J (a clearance between the end portions of the two pipes P1 and P2, and the like) in a brazing step as the subsequent step, which is preferable.

(3) Gas Introducing Step:

In the gas introducing step, the end portion of the other pipe P2 is inserted into the end portion including the enlarged diameter portion W formed in one pipe P1 of two pipes P1 and P2, and the non-oxidizing gas is introduced into the two pipes from the open hole H for filling. By introducing the non-oxidizing gas into the two pipes P1 and P2, oxygen-containing air in the two pipes P1 and P2 is substituted by the non-oxidizing gas which is less oxidative than the air. Thus, since the insides of the pipes P1 and P2 are substituted by the non-oxidizing gas, the formation of the oxide film on the inner surfaces of the pipes P1 and P2 can be prevented in the brazing-joining step as the subsequent step, and a problem is avoided in which the formation of the oxide film causes lowered performance of the air-conditioning facilities and failure of the air-conditioning facilities or devices constituting them.

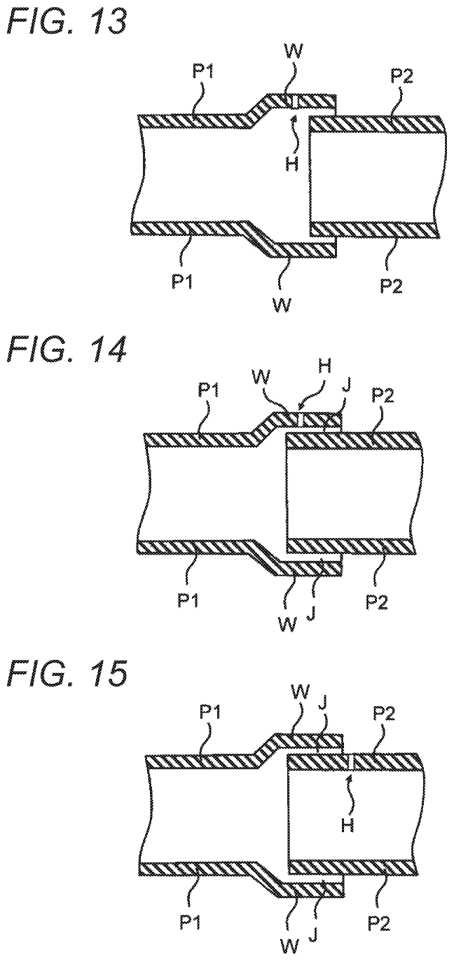

The two pipes P1 and P2 are combined by inserting the end portion of the other pipe P2 into the end portion including the enlarged diameter portion W formed in the one pipe P1, and the clearance between the end portions of the two pipes P1 and P2 is taken as the portion to be joined J. FIG. 13 is a view showing an example of a state where an end portion of other pipe P2 inserted into an end portion including an enlarged diameter portion W formed in one pipe P1 (an example in which the open hole H is formed the enlarged diameter portion W of one pipe P1). As shown in FIG. 13, first, the enlarged diameter portion W is formed. In a state where the other pipe P2 is inserted into the end portion of the one pipe P1 in which the open hole H is drilled in the enlarged diameter portion W such that (the end portion or bilge portion of) the other pipe P2 does not hide the open hole H (without blocking from the inside), the non-oxidizing gas is preferably introduced into the two pipes P1 and P2 from the open hole H.

The other pipe P2 “does not hide” the open hole H. This means, for example, a state where, when the open hole H is formed in the enlarged diameter portion W, and the inside of one pipe P1 is viewed from the open hole H (when a portion placed directly below is viewed from the open hole H, same as below), the wall surface of the other pipe P2 cannot be viewed (cannot be confirmed). Similarly, the other pipe P2 “hides” the open hole H. This means a state where, when the inside of one pipe P1 is viewed from the open hole H, the wall surface of the other pipe P2 can be viewed (can be confirmed).

Thus, by introducing the non-oxidizing gas in a state where the other pipe P2 is inserted so as not to hide the open hole H, the non-oxidizing gas can be prevented from leaking to the outside. Meanwhile, when the other pipe P2 is inserted such that the other pipe P2 hides the open hole H before the non-oxidizing gas is introduced, the introduced non-oxidizing gas may leak between the enlarged diameter portion W and end portion of the other pipe P2.

After the introduction of the non-oxidizing gas is completed, as shown in FIG. 14, the end portion of the other pipe P2 may be further inserted such that the other pipe P2 hides the open hole H (blocks from the inside). FIG. 14 is a view showing a state where the end portion of the other pipe P2 is further inserted in FIG. 13.

After the non-oxidizing gas is introduced into the two pipes from the open hole H in a state where the end portion of the other pipe P2 is inserted such that the other pipe P2 does not hide the open hole H, the end portion of the other pipe P2 is further inserted such that the other pipe P2 hides the open hole H, whereby the wall surface of the other pipe P2 is present below the open hole H. When a brazed portion B is formed in the subsequent brazing-joining step (described later), the brazing material can be prevented from intruding into the pipe P. Meanwhile, as shown in FIG. 15 described later, when the open hole H is formed in the other pipe P2, the lower side of the open hole H is in the other pipe P2, so that the brazing material may intrude into the pipe P (the other pipe P2) from the open hole H when the brazed portion is formed.

FIG. 15 is a view showing another example of a state where an end portion of other pipe P2 is inserted into an end portion including an enlarged diameter portion W formed in one pipe P1 (an example in which the open hole H is formed in the other pipe P2). FIG. 15 shows an example in which the open hole H is formed in the other pipe P2. The pipe P1 and the pipe P2 are combined in a state where one pipe P1 does not hide the open hole H formed in the other pipe P2. In this state, a non-oxidizing gas is preferably introduced into the two pipes P1 and. P2.

As the non-oxidizing gas usable in this step, an inert gas such as nitrogen gas or argon gas, and a combustion gas (exhaust gas) and the like can be used. If a high temperature combustion gas (exhaust gas) is introduced, the brazed portion will also be preheated. The combustion gas (exhaust gas) is introduced, whereby the efficiency of the work can be improved. For example, it is not necessary to bring a nitrogen cylinder to a set place.

In the gas introducing step and the brazing-joining step, a plug (not shown) in which a predetermined hole is formed is preferably attached to each of the open ends (end sides not to be joined, same as below) of the two pipes P1 and P2. By attaching the plug, the non-oxidizing gas can be efficiently introduced into the two pipes P1 and P2 while external air (air) is prevented from being introduced into the two pipes P1 and P2. The plug may be provided by attaching a predetermined tape to the open end, and forming a predetermined hole in the tape.

(4) Brazing-Joining Step:

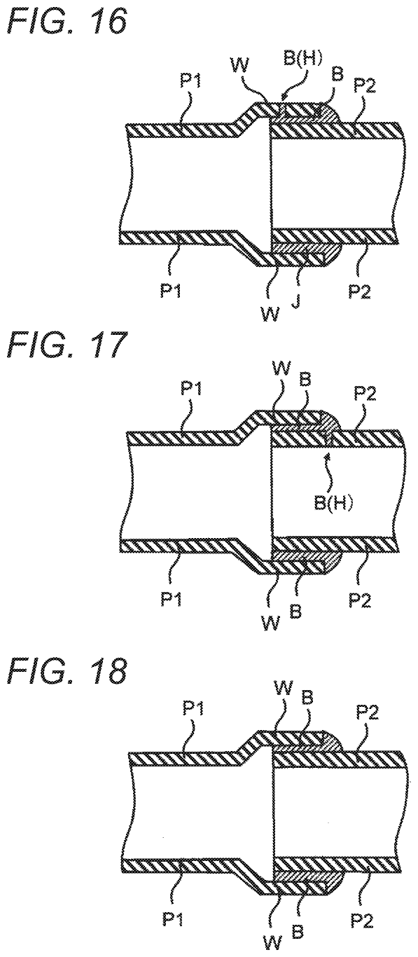

In the brazing-joining step, the two pipes P1 and P2 are joined, and the open hole H is blocked by brazing. Brazing is performed by pouring a molten brazing material into a portion to be joined J of two pipes P1 and P2 (the clearance between end portions of the two pipes P1 and P2, and the like, see FIGS. 12, 14, and 15), and cooling the brazing material to form the brazed portion B. FIG. 16 is a view showing an example in which the configuration shown in FIG. 14 is brazed. FIG. 17 is a view showing an example in which the configuration shown in FIG. 15 is brazed.

The molten brazing material is also poured into the open hole H which appears on the outside, to block the open hole H. This causes no deterioration of a sealing degree and the like due to the presence of the open hole H.

If brazing using the brazing material is performed, for example, in a state where a portion in which the end portions of the two pipes P1 and P2 are combined and the periphery thereof are heated by a burner and the like, the brazing material is efficiently melted, which is preferable.

As described above, in the method for joining pipes P according to the present invention, the two pipes P1 and P2 are joined by brazing, whereby the pipes P1 and P2 are firmly joined via the brazed portion B, and the open hole H is formed in the pipes P1 and P2 by the pipe drilling tool 1 according to the present invention in the drilling step. Therefore, the following effects of the present invention can be received: The present invention provides good operability and workability, is not liable to generate burrs, and expels cutting residue and burr residue generated during drilling to the outside of the pipes P1 and P2, which makes it possible to prevent the residues from remaining in the pipes P1 and P2. Since the insides of the two pipes P1 and P2 are substituted by the non-oxidizing gas in the gas introducing step, the formation of the oxide film on the inner surfaces of the pipes P1 and P2 can be prevented in the brazing-joining step as the subsequent step, and a problem is avoided in which the formation of the oxide film causes lowered performance of the air-conditioning facilities and failure of the air-conditioning facilities or devices constituting them.

The aspect described above indicates one aspect of the present invention. The present invention is not limited to the above described embodiment. Needless to mention, variations and improvements including the configuration of the present invention within the scope where the object and the effect can be achieved are covered by the content of the present invention. There is no problem even if a specific structure and shape and the like in carrying out the present invention may be a different structure and shape and the like within the scope where the object and the effect of the present invention can be achieved. The present invention is not limited to each embodiment described above, and variations and improvements within the scope where the object of the present invention can be achieved are covered by the present invention.

For example, in the above-described embodiment, the pedestal portion 11 is fixed to the body portion 13 by the bolt 15 and integrated, but the pedestal portion 11 and the body portion 13 may be integrated without using the bolt 13. For example, the pedestal portion 11 and the body portion 13 are integrally formed of one member.

In the method for joining the pipes P, an example has been described, in which brazing is performed in a state where the open hole H formed in the other pipe P2 appears on the outside as shown in FIGS. 15 and 17 as the case where the open hole H is formed in the other pipe P2. For example, a brazing-joining step may be performed in a state where a non-oxidizing gas is introduced from the open hole H in the state of FIG. 15, and the end portion of the other pipe P2 is further inserted, whereby the open hole H does not appear (does not appear on the outside) by the enlarged diameter portion W of the one pipe P1.

The joining of the pipes P according to the present invention is premised on joining of the two pipes P1 and P2. The joining can be used also when joining three or more pipes P, and is also covered by the scope of the present invention.

In addition, a specific structure and shape and the like in carrying out the present invention may be a different structure and the like within the scope where the object of the present invention can be achieved.

### INDUSTRIAL APPLICABILITY

The present invention can be advantageously used as means for joining pipes such as copper pipes used in air-conditioning facilities, and has high industrial applicability.

### REFERENCE SIGNS LIST

1 Pipe drilling tool (drilling tool)
11 Pedestal portion
12 Convex blade
13 Body portion
14 Positioning portion
15 Bolt
16 Scale portion
21 Die
22 Recessed portion
23 Die fixing portion
24 Moving portion
25 Supporting point portion
251 Screw
26 Fixing pin
27 Fixing pin moving hole
28 Cutting residue removing member
281 Rod-like member
282 Through hole
3 Fixed handle portion
31 Grasping side of fixed handle portion
4 Moving handle portion
41 Grasping side of moving handle portion
42 Tip of moving handle portion
B Brazed portion
W Enlarged diameter portion
H Hole (open hole)
J Portion to be joined
L Length of enlarged diameter portion
P Pipe
P1 One pipe (pipe including enlarged diameter portion)
P2 Other pipe (pipe including no enlarged diameter portion)

1. A pipe drilling tool for drilling a hole in a wall surface of a pipe, the pipe drilling tool comprising:
a rod-like pedestal portion capable of being inserted into the pipe;
a projecting convex blade attached to the pedestal portion with its tip facing an upper side;
a die including a recessed portion facing the convex blade above the convex blade and capable of being fitted with the convex blade in order to sandwich the wall surface of the pipe to be drilled between the die and the convex blade; and
a pair of handle portions including a rod-like member or a plate-like member capable of moving the die up and down closer to and away from the convex blade.

2. The pipe drilling tool according to claim 1, wherein the pair of handle portions include a fixed handle portion fixed to a body portion for fixing the pedestal portion, and a moving handle portion attached to the body portion via a supporting point portion, and including a tip rotatable with the supporting point portion as a supporting point;
the tip of the moving handle portion and the die are integrated with each other, and rotation of the tip of the moving handle portion is converted to an up-and-down movement of the die, to move the die up and down closer to and away from the convex blade.

3. The pipe drilling tool according to claim 2, wherein the tip of the moving handle portion and the die are integrated by a fixing pin disposed in a fixing pin moving hole formed in the body portion in a direction orthogonal to the up-and-down movement,
the rotation of the tip of the moving handle portion is converted to the up-and-down movement of the fixing pin, and
the die is moved up and down by the up-and-down movement of the fixing pin.

4. The pipe drilling tool according to claim 1, wherein the pedestal portion has a substantially cylindrical shape and an outer diameter of 4 to 12 mm.

5. The pipe drilling tool according to claim 1, wherein the convex blade has a substantially cylindrical shape.

6. A method for joining end portions of two pipes by brazing, using a pipe drilling tool, wherein
an enlarged diameter portion having an enlarged diameter is formed in the end portion of one of the two pipes to be joined,
the method comprising:
a drilling step of drilling an open hole appearing on the outside in one of the two pipes using the pipe drilling tool according to claim 1;
a gas introducing step of inserting an end portion of the other pipe into the end portion including an enlarged diameter portion formed in the one of the two pipes, and introducing a non-oxidizing gas into the two pipes from the open hole; and
a brazing-joining step of joining the end portions of the two pipes and blocking the open hole by brazing.

7. The method for joining pipes using a pipe drilling tool according to claim 6, wherein the drilling in the drilling step is performed in the enlarged diameter portion.

8. The method for joining pipes using a pipe drilling tool according to claim 7, wherein
the end portion of the other pipe is inserted into the end portion including an enlarged diameter portion formed in one of the two pipes is formed in the gas introducing step such that the other pipe does not hide the open hole, and
the non-oxidizing gas is introduced into the two pipes from the open hole, and the end portion of the other pipe is then further inserted to cause the other pipe to hide the open hole.

9. The pipe drilling tool according to claim 2, wherein the pedestal portion has a substantially cylindrical shape and an outer diameter of 4 to 12 mm.

10. The pipe drilling tool according to claim 2, wherein the convex blade has a substantially cylindrical shape.

11. The pipe drilling tool according to claim 3, wherein the pedestal portion has a substantially cylindrical shape and an outer diameter of 4 to 12 mm.

12. The pipe drilling tool according to claim 3, wherein the convex blade has a substantially cylindrical shape.

13. The pipe drilling tool according to claim 4, wherein the convex blade has a substantially cylindrical shape.

14. The pipe drilling tool according to claim 9, wherein the convex blade has a substantially cylindrical shape.

15. The pipe drilling tool according to claim 11, wherein the convex blade has a substantially cylindrical shape.

16. A method for joining end portions of two pipes by brazing, using a pipe drilling tool, wherein
an enlarged diameter portion having an enlarged diameter is formed in the end portion of one of the two pipes to be joined,
the method comprising:
a drilling step of drilling an open hole appearing on the outside in one of the two pipes using the pipe drilling tool according to claim 2;
a gas introducing step of inserting an end portion of the other pipe into the end portion including an enlarged diameter portion formed in the one of the two pipes, and introducing a non-oxidizing gas into the two pipes from the open hole; and
a brazing-joining step of joining the end portions of the two pipes and blocking the open hole by brazing.

17. The method for joining pipes using a pipe drilling tool according to claim 16, wherein the drilling in the drilling step is performed in the enlarged diameter portion.

18. The method for joining pipes using a pipe drilling tool according to claim 17, wherein
the end portion of the other pipe is inserted into the end portion including an enlarged diameter portion formed in one of the two pipes is formed in the gas introducing step such that the other pipe does not hide the open hole, and
the non-oxidizing gas is introduced into the two pipes from the open hole, and the end portion of the other pipe is then further inserted to cause the other pipe to hide the open hole.
